(19) United States
(12) Patent Application Publication
(10) Pub. No.: US 2008/0136671 A1
(43) Pub. Date: Jun. 12, 2008

(54) TRAFFIC INDICATOR CAPABLE OF DISPLAYING DIFFERENT TYPES OF TRAFFIC LIGHTS AND SYMBOLS

(76) Inventor: Yih-Jiun Shen, Kaohsiung (TW)

Correspondence Address: PATENTTM.US, P. O. BOX 82788, PORTLAND, OR, 97282-0788, US

(21) Appl. No.: 11/608,754

(22) Filed: Dec. 8, 2006

(51) Int. Cl. G08G 1/095

(52) U.S. Cl. 340/907

(57) ABSTRACT

A traffic indicator has a base, a circuit board mounted in the base, an LED panel mounted in the base and a protect lid mounted on the base to cover the circuit board and the LED panel. The LED panel is controlled by the circuit board to display traffic lights such as red, green or yellow and traffic symbols such as right and left turn indications. Furthermore, the traffic indicator also displays countdown information about the remaining seconds after which the present displayed traffic light will be changed. Therefore, a single traffic indicator described above is able to replace the conventional traffic lights. Since the traffic indicator has only one display screen, the traffic symbols can be displayed in a larger size to improve the recognition on traffic signs at crossroads.

### BACKGROUND OF THE INVENTION

1. Field of the Invention

The present invention relates to a traffic indicator, especially to a traffic indicator that is capable of displaying different types of traffic lights and symbols with a remaining time indication.

2. Description of the Prior Arts

The traffic signs mainly comprise dynamic type and static type. The static traffic signs, such as road signs, are suitable for indicating traffic rules or speed limitations. The dynamic traffic signs are often composed of lights, for instance, the traffic lights or pedestrian lights.

For crossroads where the amount of traffic is not large, a set of fundamental red, green and yellow lights is enough for controlling the traffic. However, for places with heavy traffic, moving direction lights are often used accompanying the fundamental traffic lights. Therefore, a crossroad may need a lot of lights of different functions to handle the traffic. As a result, drivers may not promptly respond to the changes of these lights.

To overcome the shortcomings, the present invention provides a traffic indicator to mitigate or obviate the aforementioned problems.

### SUMMARY OF THE INVENTION

The main objective of the present invention is to provide a single traffic indicator capable of simultaneously displaying the traffic lights, traffic symbols and countdown information depends on practical requirements at different crossroads.

The traffic indicator has a base, a circuit board mounted in the base, an LED panel mounted in the base and a protect lid. Based on the control of the circuit board, the LED panel composed of multiple LEDs of different colors is able to display different traffic lights as well as traffic symbols. In other words, a single display screen can show red, green or yellow traffic lights, moving direction symbols and countdown information. Since the traffic indicator has only one display screen, the traffic symbols can be displayed in a larger size so that drivers can easily recognize the traffic symbols. Furthermore, to compare with the conventional LED-based traffic light equipped with multiple display screens, the traffic indicator with only one display screen requires less fabricating and upkeep costs.

Another objective of the present invention is to provide a function of adjusting brightness of the traffic indicator. The traffic indicator uses an optical sensor to detect the intensity of light of surroundings. Based on the detected result, the circuit board can accordingly adjust the brightness of the LEDs on the LED panel.

Other objectives, advantages and novel features of the invention will become more apparent from the following detailed description when taken in conjunction with the accompanying drawings.

### BRIEF DESCRIPTION OF THE DRAWINGS

FIG. 1 is an exploded cross section view of a traffic indicator in accordance with the present invention;

FIG. 2 is a block diagram of a control circuit for the traffic indicator in accordance with the present invention;

FIG. 3 is a plan view of the traffic indicator in accordance with the present invention;

FIG. 4 is an operational view of the traffic indicator in accordance with the present invention showing a red light with a black or other color right turn symbol and a countdown indication of 20 seconds;

FIG. 5 is an operational view of the traffic indicator in accordance with the present invention showing a green light with a black or other color right/left turn symbol and a countdown indication of 35 seconds; and

FIG. 6 is an operational view of the traffic indicator in accordance with the present invention showing a green light with a black or other color left turn symbol and a countdown indication of 46 seconds.

### DETAILED DESCRIPTION OF THE PREFERRED EMBODIMENTS

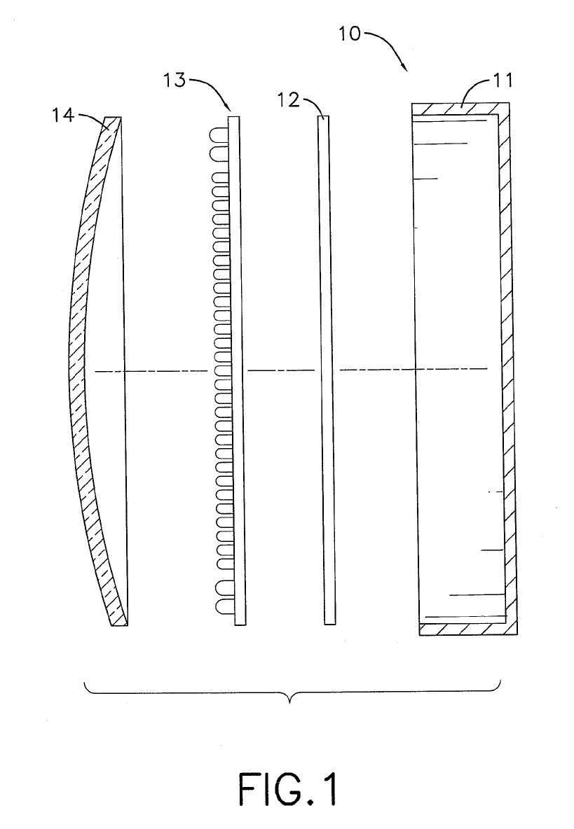

With reference to FIG. 1, a traffic indicator (10) in accordance with the present invention comprises a base (11), a circuit board (12), an LED panel (13) and a protect lid (14).

The protect lid (14) can be made of translucent or transparent material and is mounted on the base (11) to cover the circuit board (12) and the LED panel (13).

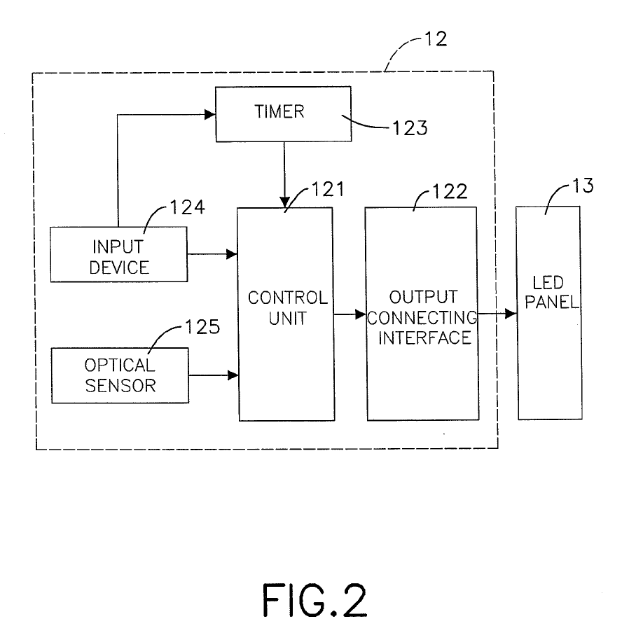

With reference to FIG. 2, a control circuit on the circuit board (12) for the traffic indicator (10) comprises a control unit (121), an output connecting interface (122), a timer (123), an input device (124) and an optical sensor (125).

The output connecting interface (122) is connected between an output terminal of the control unit (121) and an input terminal of the LED panel (13). Through the output connecting interface (122), the control unit (121) can turn on or turn off each of the LEDs, and controls their color and brightness.

The timer (123) has an output terminal connecting to the control unit (121) and an input terminal connecting to the input device (124).

The input device (124) can be a key set or a switch set, and has output terminals respectively connecting to the control unit (121) and timer (123) for setting operation parameters to the control unit (121) and timer (123).

The optical sensor (125) connected to the control unit (121) detects the intensity of the light of the surroundings. The detected result is transmitted to the control unit (121). Based on the detected result, the control unit (121) can adjust the brightness of LED panel (13).

The LED panel (13) is mounted in the base (11) and electrically connects to the circuit board (12). The LED panel (13) comprises multiple light emitting diodes (LEDs) of different colors thus, the circuit board (12) can control the LED panel (13) to display red, yellow or green light in a large-area to form a traffic light.

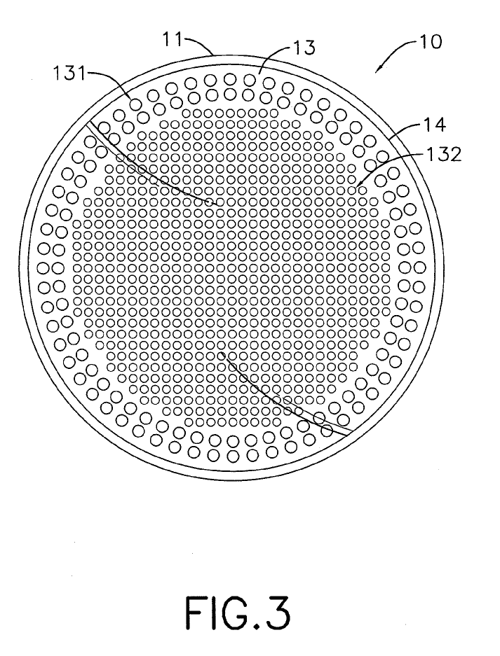

As shown in FIG. 3, the LED panel (13) has two display regions. The first display region is an outer ring region (131). The second display region is a center circular region (132) within the outer ring region (131). Furthermore, the outer ring region (131) provides a function of countdown. For example, the entire outer ring region (131) can be divided into sixty sections corresponding to sixty seconds of a clock. When the center region (132) displays a traffic symbol or a sign, the originally activated sixty sections of LEDs in the outer ring region (131) can be either sequentially turned off in a counterclockwise direction to show the remaining seconds or sequentially turned off for one second in a counterclockwise direction to generate a visual effect of a moving dot. Alternatively, the sixty sections of LEDs in the outer ring region (131) are sequentially turned on for one second in a counterclockwise direction to generate a visual effect of a moving light dot as a moving second hand.

The displayed color of the outer ring region (131) is subjected to the color of center region (132). The countdown of remained time may be less than 60 seconds or longer than 1 minute subjected to the traffic load at crossroad but the countdown indications above are activated well while the setting of countdown is less than 61 seconds.

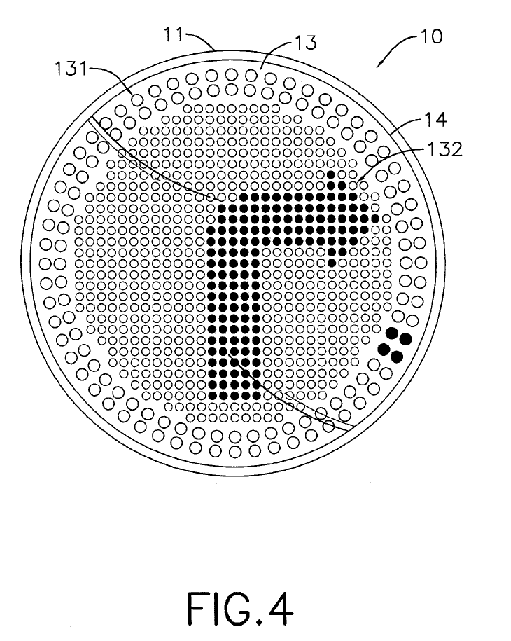

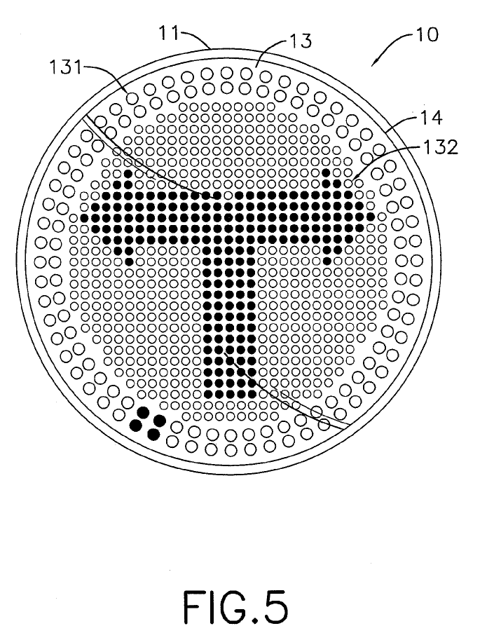

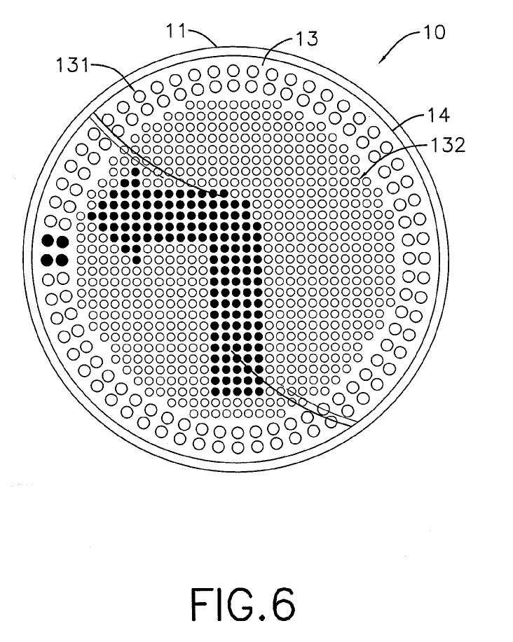

Therefore, the drivers can recognize the remaining seconds from the indications above after which the present displayed traffic symbol will be changed. Furthermore, the center circular region (132) can display all desired patterns of traffic symbols as long as these patterns are pre-set or pre-programmed in the circuit board (12). For example, the center region (132) shows a right turn symbol on FIG. 4, a right/left turn symbol on FIG. 5 and a left turn symbol on FIG. 6. Accordingly, the direction indications above can either illuminate right/left turn symbols alone as a direction indicator or black out the right/left turn symbols when the center circular region (132) lights up as a traffic light.

According to the foregoing description, a single traffic indicator in accordance with the present inventions is able to display all desired patterns of traffic symbols based on the pre-set or pre-programmed settings in the circuit board (12) to meet different requirements of the crossroads. Therefore, the conventional traffic lights can be reduced to one single traffic indicator.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A traffic indicator capable of displaying different types of traffic lights and symbols, the traffic indicator comprising:
a base;
a circuit board mounted in the base;
a light emitting diode (LED) panel mounted in the base, and comprising multiple light emitting diodes (LEDs) of different colors; and
a protect lid made of translucent or transparent material and mounted on the base to cover the circuit board and the LED panel in the base.

2. The traffic indicator as claimed in claim 1, the circuit board comprising:
a control unit;
an output connecting interface connected between the control unit and the LED panel, wherein the control unit controls the LEDs of the LED panel through the output connecting interface;
a timer having an output terminal connected to the control unit and an input terminal connected to an input device;
the input device, being either a key set or a switch set, connected to the control unit and the timer for setting control parameters to the control unit and the timer; and
an optical sensor connected to the control unit.

3. The traffic indicator as claimed in claim 1, wherein the LED panel comprises an outer ring region and a center circular region; both lighting in same color.

4. The traffic indicator as claimed in claim 3, wherein all LEDs of the outer ring region are divided into sixty sections corresponding to sixty seconds of a clock.

5. The traffic indicator as claimed in claim 4, wherein sixty sections of LEDs in the outer ring region are initially turned on then sequentially turned off in a counterclockwise direction to show the countdown information.

6. The traffic indicator as claimed in claim 4, wherein sixty sections of LEDs in the outer ring region are initially turned on then sequentially turned off for one second to generate a moving dot in a counterclockwise direction as a second hand pointing to the countdown seconds.

7. The traffic indicator as claimed in claim 4, wherein sixty sections of LEDs in the outer ring region are sequentially turned on for one second in a counterclockwise direction to generate a moving light dot to indicate the remaining seconds.

8. The traffic indicator as claimed in claim 3, wherein the traffic signs displayed by the center circular region comprise red, green and yellow lights and traffic symbols.

9. The traffic indicator as claimed in claim 2, wherein the optical sensor detects the intensity of light of surroundings to adjust brightness of the LED panel through the control unit.
